(19) United States
(12) Patent Application Publication
(10) Pub. No.: US 2016/0071352 A1
(43) Pub. Date: Mar. 10, 2016

(54) Side bets for waging numbers games

(71) Applicant: Kathleen Nylund Jackson, Scituate, MA (US)

(72) Inventor: Kathleen Nylund Jackson, Scituate, MA (US)

(73) Assignee: Precedent gaming, Inc., Scituate, MA (US)

(21) Appl. No.: 14/756,485

(22) Filed: Sep. 9, 2015

Related U.S. Application Data
(60) Provisional application No. 62/070,991, filed on Sep. 10, 2014.

(51) Int. Cl. G07F 17/32

(52) U.S. Cl. CPC G07F 17/32; G07F 17/329

(57) ABSTRACT

A method of playing a side bet associated with a wagering numbers game is disclosed. The method utilizes the numbers drawn in a number-based game, in particular keno, bingo and lottery games. The number-based game comprises a predetermined set of numbers from which a subset of numbers is randomly drawn. A predetermined amount of subset numbers is provided by a draw, either by a random number generator or physical numbered balls in a hopper. The drawn numbers are analyzed and a determination is made as to the highest number X and the lowest number Y thereof, and the difference between those two said numbers (X−Y) defines the winning number for the side bet. The side bet is resolved against a predetermined paytable.

### RELATED APPLICATION DATA

This Application claims priority from U.S. Provisional Patent Application Ser. No.: 62/070,991, filed Sep. 10, 2014, and having the Title SIDE BETS FOR WAGERING NUMBERS GAMES.

### BACKGROUND OF THE INVENTION

1. Field of the Invention

The present invention relates to wagering games and side bets suitable for use in casinos, gaming establishments, internet sites or mobile devices as a lottery game, an electronic machine game, or an electronic device game.

2. Background of the Art

Keno is one of the oldest wagering games in the world, and is popular as both a state lottery game and casino game. It is a simple game that provides varying awards with varying odds. Players can bet on “catching” from 1 to a maximum X amount of numbers from a draw of 20 numbers out of 80 (1 to 80, inclusive) numbers, the maximum number X being determined by the particular game rules. For instance, the Massachusetts State Lottery allows a player to bet on 1 to 12 numbers. A traditional live casino keno game uses a circular glass enclosure called a “bubble” containing 80 balls which determine the ball draw result with each ball imprinted with a number 1 through 80. In state lotteries and other electronic versions, a computer driven random number generator selects the winning numbers for each drawing. The following are the rules for basic keno: a) the player makes a wager and indicates which numbers he wishes to pick. The picks are made on a slip of paper in live keno or by touching the screen or pressing buttons in video keno. The range of numbers the player may pick from is 1 to 80 inclusive; b) the number of picks the player may make depends on the game itself For example, the range may be 2 to 10 or 1 to 15; c) the game will randomly choose 20 out of 80 balls; and d) if the game chooses a number the player chose that is known as a “catch.” The player is paid according to the amount of numbers he catches.

Bingo is played by initially providing a predetermined set of numbers. Numbers are randomly drawn until at least one predetermined winning pattern of numbers is attained. Basically, players buy cards with numbers on them in a 5×5 grid corresponding to the five letters in the word B-I-N-G-O. Numbers such as B-2 or O-68 are then drawn at random (out of a possible 75 in American Bingo, and 90 in British and Australian Bingo) until one player completes a “Bingo” pattern, such as a line with five numbers in a vertical, horizontal or diagonal row on one of their cards and wins the prize. Each card is different, and there are many possible patterns to play for.

Powerball® is a popular two-drum lottery game. One drum holds 59 white balls, while the other drum holds 39 red balls. The red ball is the Powerball. The player buys a ticket, selecting five numbers (these winning numbers are drawn from the first drum with the white balls) and one Powerball number (the winning Powerball number is drawn from the second drum with the red balls). To win the Powerball Jackpot, the player must match all five white balls in any order, as well as the red Powerball. Smaller cash prizes are provided for getting as little as one correct number (the Powerball).

Prior art has taught numerous methods to provide a side bet for number-based games.

United States Patent Application No. 20140051491 (Johnson) discloses a lottery-type game enabled via two or more casino games such as keno or video poker games. If designated indicia comprising certain indicia from the first and second games match a selected set of indicia, then the lottery-type game is winning. In the case of a keno game, the designated indicia may be certain player numbers from the keno games and in the case of a poker game, certain player-selected cards. The selected set of indicia may comprise drawn keno numbers or dealt cards.

United States Patent Application No. 20140011562 (Smith, et al.) teaches a method and system to play a side bet wagering game. A wager is placed on a game that provides a random set of 20 numbers, with the random set of numbers organized into two columns or two rows of number pairs. The number pairs are summed to form a number pair total outcome that are then are ordered in accordance with an order of highest number pair total outcome to lowest total number pair outcome. The side bet wager is resolved on correspondence of the ordered number pair outcomes to a preselected number pair outcome associated with the wager on the game.

United States Application No. 20120122541 (Meyer) discloses a gaming system, gaming device, and method for providing a bingo-type game having a first award evaluation based on combinations of symbols indicated on one or more bingo cards which match a plurality of randomly selected displayed symbols and a second award evaluation based on the order in which the displayed randomly selected symbols are selected for the first evaluation.

United States Application No. 20120108307 (Schultz, et al.) discloses a gaming system that may be operable to store a first set of operational rules for determining a first condition for a primary game, and a second set of operational rules for determining a second condition for a side game that is different from the primary game. In an example embodiment of the disclosure, the primary game may be a slot game while the side game may be a different game than the slot game. For example, the side game can include one of a variety of games, including Poker, Caribbean Stud Poker, Roulette, Blackjack, Pai Gow, Bingo, Keno, Craps, or any other type of game.

United States Application No. 20070281774 (Khai) describes a method of playing a keno game of chance that allows a player to potentially multiply his winnings by a factor of up to five (5) times the normal winning ticket payout amount by placing an additional wager on the game.

United States Patent Application No. No. 20070173312 (Dodge) describes a keno game wherein a player selects up to ten numbers from a field of eighty numbers to be played and these numbers are compared to twenty numbers randomly selected by the game from the same field of numbers in a manner known in the prior art. When the player places one or more conventional bets on the outcome of the game, he may also place one or more side bets as to the number of hits or matches there will be between the player selected numbers and twenty numbers selected by the game computer.

United States Application No. 20060094494 (O'Halloran, et al.) discloses a keno game that incorporates a bonus feature. For each game, a predetermined condition is set to designate a specific ball. For example, the predetermined condition may be that the specified ball will be the last number drawn. If the ball is drawn as defined, a bonus prize is paid.

U.S. Pat. No. 6,702,669 (Moody) discloses game of chance that is based on a keno-type game which uses one or more groups of number ranges, such as a HI group of number ranges, a LO group of number ranges and a HI/LO group of number ranges. The drawn numbers are added up to determine a numerical total. The number range in which the numerical total falls is determined and the player is provided an award based on the payout odds for the number range within which the numerical total falls.

U.S. Pat. No. 5,106,089 (Wood) discloses a lottery summing game that consists of a lotto game wherein a player selects a play symbol representing a combination of play symbols from a set of play symbols. A set of winning play symbols is randomly selected and then compared to the combination of play symbols chosen by the player.

Each of the references discussed in this text art are incorporated herein in their entirety for all purposes including enablement of single and multiplayer platforms and structures for the execution of games.

It is still desirable to create a potentially lucrative, easy-to-understand side bet for wagering numbers games that is resolved at the same time that the base numbers game is resolved, and that may or may not require a wager on the base numbers game.

### SUMMARY OF THE INVENTION

A method of providing a side bet for wagering number games utilizes the numbers drawn in a number-based game, in particular keno, bingo and lottery games, although any other game comprising a set of numbers from which a random subset of numbers is drawn is within the scope of the present invention. In a preferred embodiment, the player wagers to play a side bet for a base game of keno by selecting at least one number from a predetermined set of side bet numbers. The keno game comprises a predetermined set of numbers, preferably from 1 to 80 inclusive. A predetermined amount of numbers, preferably 20 numbers, from the predetermined set of numbers is provided by a draw, determined either by a random number generator or physical numbered balls in a hopper. The drawn numbers are analyzed and a determination is made as to the highest number X and the lowest number Y, and the difference between those two said numbers (X−Y) defines the winning number for the side bet. The side bet is resolved against a predetermined paytable.

### BRIEF DESCRIPTION OF THE FIGURES

FIG. 1A shows the front of a betting slip according to an embodiment of the present invention.

FIG. 1B shows the back of the betting slip according to an embodiment of the present invention.

FIG. 1C shows a play ticket according to an embodiment of the present invention.

FIG. 2A shows a monitor screen and the front of a bingo wagering card with a first resolution of a side bet according to an embodiment of the present invention.

FIG. 2B shows the monitor screen and the front of the bingo wagering card with a second resolution of a side bet according to an embodiment of the present invention.

FIG. 3A shows a monitor screen and a play ticket for a four-digit daily numbers lottery game with a resolution of a side bet according to an embodiment of the present invention.

FIG. 3B shows a monitor screen and a play ticket for a five-number draw lottery game with a resolution of a side bet according to an embodiment of the present invention.

FIG. 3C shows a monitor screen and a play ticket for a progressive lottery game with a resolution of a side bet according to an embodiment of the present invention.

### DETAILED DESCRIPTION OF THE INVENTION

A method of providing a side bet associated with a base wagering numbers game (i.e., keno, bingo, lottery games and the like) for at least one player on a gaming system comprises: at least one processor; a gaming apparatus having at least one input device and at least one display device; and at least one memory device which stores a plurality of instructions which, when executed by the at least one processor, cause the at least one processor to operate with the at least one display device and the at least one input device to provide the steps to: a) enable a player to place at least one wager on at least one side bet associated with a base wagering numbers game; b) establish at least one predetermined initial set of unique numbers to be used in the play of the base wagering numbers game; c) provide a predetermined set of unique numbers as wagerable numbers for the side bet; d) provide at least one predetermined amount of randomly selected numbers from the at least one predetermined initial set of numbers; e) identify at least some of the predetermined amount of randomly selected numbers as fundamental elements of the at least one side bet; f) determine a highest number X from the fundamental elements and a lowest number Y from the fundamental elements; g) determine a final value according to a mathematical formula based on the highest number X and the lowest number Y; h) establish a predetermined paytable for the wagerable numbers of the side bet associated with the at least one side bet wherein payouts are based on at least the odds of occurrence of the final value; and i) resolve the at least one side bet according to the predetermined paytable.

It may or may not be mandatory to play the base numbers game in order to play the side bet game.

Specific embodiments of the present invention are shown below and disclosed according to the base game.

### Keno

A base keno game may be played by utilizing a plastic/metal cage containing preferably 80 balls, wherein each ball is numbered from 1 to 80 inclusive and wherein the numbered balls are forced out through an air blower to determine the winners. This is called the “live” version. Most modern keno machines, statewide lotteries and online applications use a gaming system comprising at least a processor, input device and monitor screen to generate and display winning numbers.

A method of playing the base keno game comprises the steps to: a) provide a physical (or electronic) betting slip that displays at least a grid of a total amount of predetermined selectable numbers, and preferably separate grids that display the quantity of selectable numbers selected, the amount bet per game, and the amount of games played; b) allow a player to mark the betting slip with a pen/pencil (or in the electronic version by pressing the numbers on a touchscreen or using an input device) to select at least one number from the total amount of selectable numbers up to a predetermined maximum amount of numbers; c) process the betting slip to validate the wager and provide the player with a play ticket displaying at least the total amount of selectable numbers, the player-selected numbers, a keno game-identifying number, the amount wagered per game and the amount of games played; d) allow a processor to randomly select a predetermined amount of selectable numbers as winning numbers drawn; e) compare the player-selected numbers with the winning numbers drawn; and f) resolve the wager according to a predetermined paytable.

In a first preferred embodiment of the present invention, and utilizing the method as disclosed in the description immediately above, a base keno game comprises 80 selectable numbers and 20 numbers randomly selected by a processor. The method of the keno side bet game comprises the steps to: a) provide a physical (or electronic) betting slip that displays at least a grid of a total amount of predetermined selectable side bet numbers differing from the total amount of predetermined selectable numbers of the base keno game, and preferably separate grids that display the quantity of selectable numbers selected as side bets, the amount bet per side bet, and the amount of games played; b) allow a player to mark the betting slip with a pen/pencil (or in the electronic version by pressing the numbers on a touchscreen or using an input device) to select at least one number from the total amount of selectable side bet numbers up to a predetermined maximum amount of numbers; c) process the betting slip to validate the wager and provide the player with a play ticket displaying at least the total amount of player-selected numbers, the player-selected numbers, a keno side bet game-identifying number, the amount wagered per side bet and the amount of games played; d) allow the processor to randomly select (or draw) the 20 numbers as the 20 winning numbers in the base game; e) identify the 20 winning numbers in the base game as fundamental elements of the at least one side bet; f) determine a highest number X from the fundamental elements and a lowest number Y from the fundamental elements; g) define a final value for the side bet as the difference between those two said numbers (X−Y); h) establish a predetermined paytable for the selectable numbers of the side bet associated with the at least one side bet wherein payouts are based on at least the odds of occurrence of the final value: For example, if the highest winning number is 78 and the lowest winning number is 4, the winning number for the side bet is 78−4, or 74; and i) resolve the at least one side bet according to the predetermined paytable.

The side bet is then resolved against a first predetermined paytable. The paytable reflects the odds of each attainable difference occurring, with different payouts being based on the different odds thereof. If 20 numbers are drawn, the lowest possible difference will be 19, since the 20 drawn numbers can possibly, but not probably, comprise 20 consecutive numbers (for example, the draw of 31, 32, 33, 34, 35, 36, 37, 38, 39, 40, 41, 42, 43, 44, 45, 46, 47, 48, 49, 50 has a high number of 50 and a low number of 31, and 50−31=19). Although there are 61 ways to provide a difference of 19, the odds of drawing 20 consecutive numbers is literally next to zero, and so the payout for such a rare occurrence would be necessarily a huge jackpot win, for example $100,000 for $1 wagered. The highest difference of 79 can only occur one way: 80−1, but the odds are 1 in 16, so it results in a much lesser win, for example $10 for $1 wagered. Differences of 75, 76, and 77 have the best odds of occurring, so each will result in the smallest win, for example $6 for $1 wagered.

In a second preferred embodiment of the present invention, the gameplay is the same as in the first preferred embodiment, except that the determined lowest winning number Y is added to the determined highest winning number X instead of the determined lowest winning number Y being subtracted from the determined highest winning number X. The sum total of those two said numbers (X+Y) defines the final value for the side bet. For example, if the highest winning number is 78 and the lowest winning number is 4, the winning number for the side bet is 78+4, or 82. The side bet is then resolved against a second predetermined paytable.

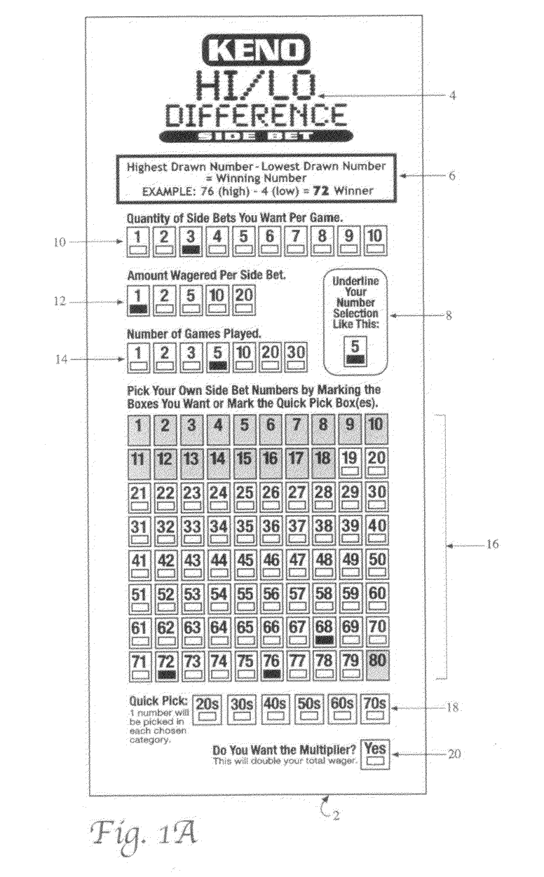

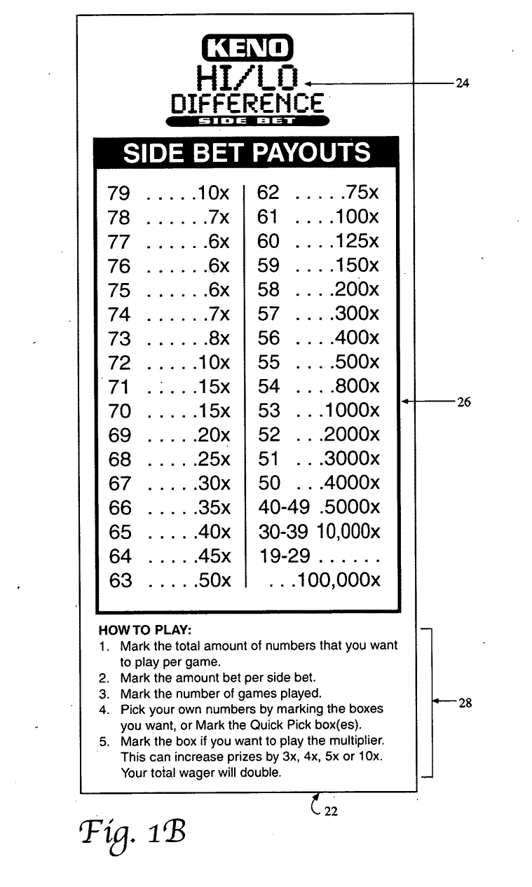

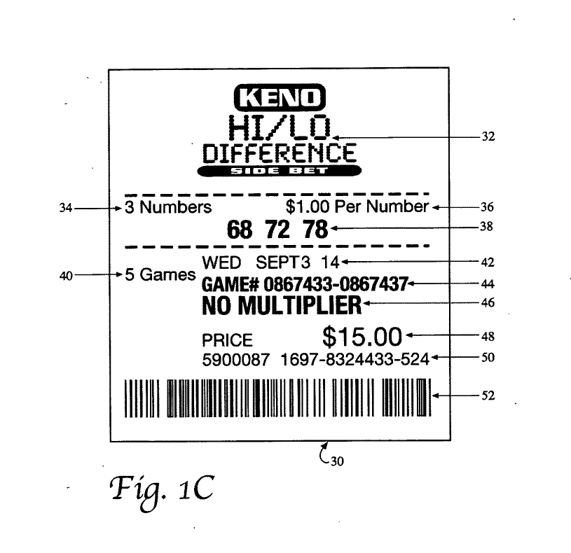

References to FIG. 1A, FIG. 1B and FIG. 1C will assist in further understanding of the practice of the present invention. A base game of keno (with 20 numbers being randomly drawn from a predetermined set of 80 unique numbers) is described in the Figures below.

FIG. 1A shows the front of a betting slip 2, and displays an area 4 with the name of the keno side bet, a brief explanation and example 6 of the side bet, and instructions for marking the boxes 8. The player first marks the total amount of side bet numbers that he wants to play per game 10. The player marks the amount in dollars that he wants to play per side bet 12, and the number of games played 14. A grid of 80 unique numbers 16 provides the player with 61 playable numbers (shown in white with markable boxes) and 19 unplayable numbers (shown in grey without markable boxes). In lieu of marking any boxes in the grid 16, the player may choose to instead mark at least one Quick Pick box, each Quick Pick box indicating a category of a range of numbers 18. One number will be selected by the processor in each marked category. Conversely, at least two numbers may be selected by the processor in each marked category. The keno side bet may include a multiplier bonus opportunity 20 for an additional wager. The multiplier bonus opportunity provides a random multiplier that may be applied to a winning result; for example, a 1×, 3×, 4×, 5×or 10× multiplier may be randomly selected by the processor prior to, during or after the results of the base keno game are determined. Once the betting slip is completely filled out, the slip (whether a physical betting slip marked by a pen/pencil or an electronic betting slip marked by pressing physical machine or touchscreen buttons) is then processed to provide the player with a play ticket (physical or virtual). The betting slip must be processed before any play of the keno game. The activity of the keno game is then performed with the processor drawing 20 winning numbers. The processor then determines the highest number X from the 20 drawn numbers and the lowest number Y from the 20 drawn numbers. X−Y determines the winning side bet number, and the side bet is then resolved against a predetermined paytable. In FIG. 1A, the player has chosen to make a wager to play five games, each comprising three side bet numbers (68, 72, 76) at $1:00 wager per side bet number, for a total wager of $15.00.

FIG. 1B refers to the betting slip 2 in FIG. 1A, and shows the back 22 of the betting slip 2. The back displays an area 24 showing the name of the keno side bet and a sample paytable 26 comprising the payouts for each number 79 through 19 inclusive. Instructions on How to Play 28 are also shown.

FIG. 1C shows a keno side bet play ticket 30 (printed or virtual), and refers to the elements of FIG. 1A. The play ticket displays an area 32 with the name of the keno side bet, the total amount of side bet numbers per game selected by the player 34, the amount wagered per side bet number 36, and the side bet numbers selected by the player 38. The date of the game(s) played 42 is also shown. The amount of games played 40, the game number(s) referring to each specific game played 44, a determination as to whether or not the player has chosen to play the multiplier bonus 46, and the total price of the play ticket 48 are shown. A security identification number 50 for the play ticket is shown and a UPC code 52 is provided.
As an example of the resolution of the side bets as described in FIGS. 1A and 1B:
1) the processor has selected these 20 numbers in the first keno game #0867433: 2, 5, 8, 15, 16, 17, 28, 35, 39, 41, 42, 49, 52,54, 57, 63, 70, 71, 75, 80. The side bet difference is 80−2=78. The player wins 7× the $1.00 individual side bet on 78 (while forfeiting the $1.00 wager), and loses his side wagers on side bet numbers 68 and 72.
2) the processor has selected these 20 numbers in the second keno game #0867434: 9, 15, 16, 17, 26, 27, 28, 35, 39, 40, 42, 51, 52, 54, 57, 63, 65, 67, 72, 73. The side bet difference is 73−9=64. The player loses all side wagers on side bet numbers 68, 72 and 78.
3) the processor has selected these 20 numbers in the third keno game #0867435: 1, 5, 7, 15, 19, 20, 28, 35, 39, 44, 42, 48, 52, 54, 59, 66, 68, 73, 74, 80. The side bet difference is 80−1=79. The player loses all side wagers on side bet numbers 68, 72 and 78.
4) the processor has selected these 20 numbers in the fourth keno game #0867436: 4, 6, 9, 11, 12, 17, 28, 35, 38, 41, 46, 49, 51, 54, 57, 64, 67, 69, 70, 72.The side bet difference is 72−4=68. The player wins 25× the $1.00 individual side bet on 68 (while forfeiting the $1.00 wager), and loses his side wagers on side bet numbers 72 and 78.
5) the processor has selected these 20 numbers in the fifth keno game #0867437: 10, 13, 14, 15, 16, 22, 28, 35, 36, 41, 45, 49, 52, 54, 61, 67, 73, 75, 79, 80. The side bet difference is 80−10=70. The player loses all side wagers on side bet numbers 68, 72 and 78.

Referring to FIG. 1A and FIG. 1C, the player has made a $15.00 wager to play three numbers for five games, and in the examples 1-5 above, the player wins $7.00+$25.00, for a total win of $32.00. The $15.00 wager is not returned to the player, although it is contemplated that any wager on a winning result may be returned to the player.

### Bingo

In a further embodiment of the present invention, a physical or electronic bingo game is provided that comprises a predetermined set of numbers 1 through 75 inclusive. Numbers are drawn using a “bubble” containing 75 balls which determine the ball draw result with each ball imprinted with a number 1 through 75, or by a computer driven random number generator that selects the winning numbers for each drawing. Numbers are drawn one at a time. The player preferably purchases at least one unique bingo wagering card, comprising five columns labeled B-I-N-G-O by five rows (a first column comprising five numbers out of the numbers B1-B15, a second column comprising five numbers out of the numbers I16-I30, a third column comprising four numbers out of the numbers N31-N45 and including a “FREE” space, a fourth column comprising. five numbers out of the numbers G46-G60, and a fifth column comprising five numbers out of the numbers O61-O75). Only the digits, and not the letters, may be fundamental elements used to determine the side bet. As the numbers are drawn, the player (or processor) marks any number on a bingo wagering card that matches a drawn number. When a predetermined pattern of numbers on a bingo wagering card is achieved as a predetermined winning pattern of matching numbers, a prize in the base game may be provided. Prior to the commencement of the base game, if the player has made at least one wager on at least one bingo side bet from a predetermined set of numbers differing from the predetermined set of numbers in the base game, the side bet is also now resolved. The side bet may be determined by the highest number X drawn to this point and the lowest number Y drawn to this point, or by the highest number X in the winning pattern and the lowest number Y in the winning pattern. It is contemplated that there may be more than one resolution of the side bet; the side bet may be resolved after each of predetermined various winning patterns is achieved in the base game. It may or may not require an additional wager for each resolution of the side bet. For example, a first bingo side bet may be placed on a resolution being determined at the occurrence of a pattern win of “Bingo!” (five matching numbers in a horizontal, vertical or diagonal pattern), and a second bingo side bet may be placed on a resolution being determined at the occurrence of a cover-all pattern win (all 25 numbers including the FREE space on the bingo card being matches). In contrast, only one bingo side bet may be placed to play all of the resolutions.

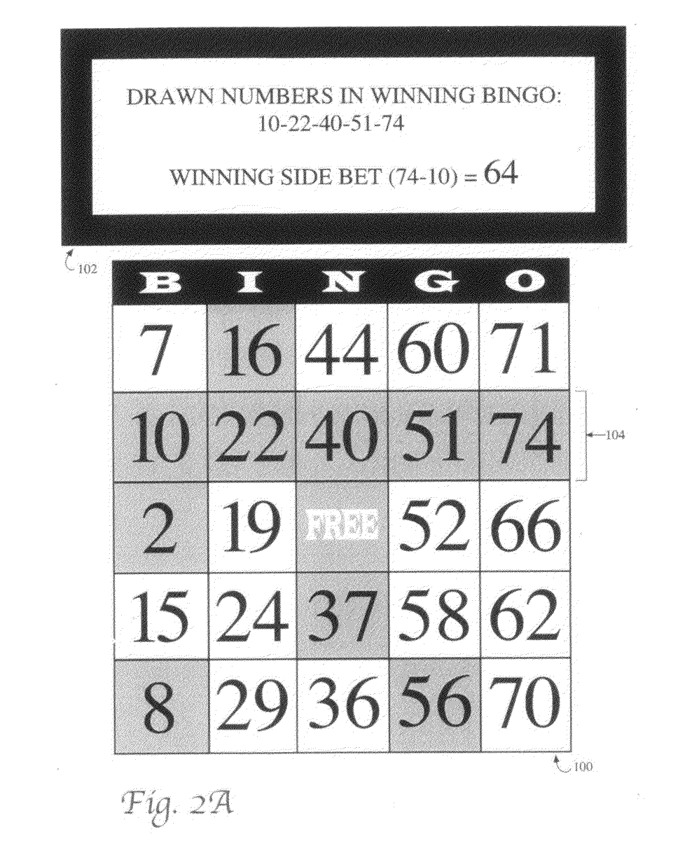

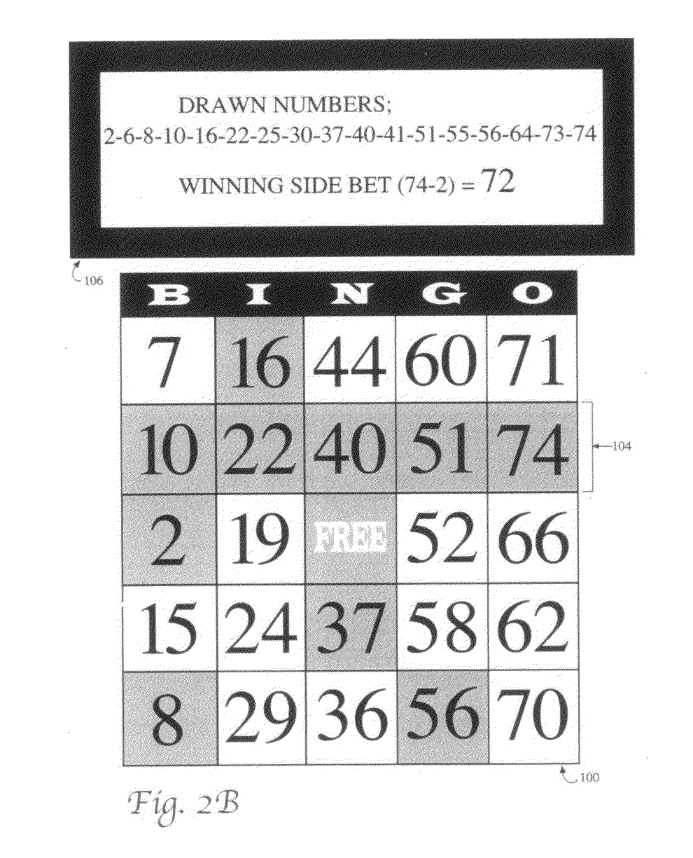

References to FIG. 2A and FIG. 2B will assist in further understanding of the practice of the present invention. A base game of bingo (with numbers being randomly drawn one at a time from a predetermined set of 75 unique numbers) is described in the Figures below.

FIG. 2A shows a bingo wagering card 100, comprising five columns designated by the letters B-I-N-G-O by five rows of random numbers from the number set 1 through 75 inclusive. The middle spot in the N column is a free spot that can stand for any number. If a player wishes to make at least one side bet, the wager is made on a betting slip (not shown) that is the processed to verify the wager, or may be printed or preprinted on the wagering bingo card itself. A monitor screen display device 102 is also shown. A random selection of a predetermined set of numbers from 1 to 75 inclusive are selected one at time. Each selected number is a winning number and is “called out” and may be displayed on the display device. (In this example, the display is for displaying winning patterns only.) As each winning number is selected and “called”, the player (or processor in an electronic. version) marks any number that matches a winning number. The marked numbers are shown in grey. The player has attained a winning pattern of “Bingo!”: in the second row 104, the player has five matched numbers to make the bingo. The base game is then paused, as the winning Bingo! numbers are displayed on the display device. The fundamental elements of the side bet are the five numbers in the winning Bingo! pattern. The processor then determines the highest number X (74) from the five said winning numbers, and the lowest number Y (10) from the five said winning numbers. X−Y determines the winning side bet number, and the side bet is then resolved against a predetermined paytable (not shown). The winning numbers for the Bingo! win are 10-22-40-51-74, and the winning number for the side bet is (74−10)=64 final value.

FIG. 2B shows the same bingo wagering card 100 as in FIG. 2A. The play of the base game is the same as in FIG. 2A. A separate monitor screen display device 106 is also shown. A random selection of the predetermined set of numbers from 1 to 75 inclusive is selected one at time. Each selected number is a winning number and is “called out” and may be displayed on the display device. (In this example, the display is for displaying all numbers chosen to date.) As each winning number is selected and “called”, the player (or processor) marks any number that matches a winning number. The marked numbers are shown in grey. The player has attained a winning pattern of Bingo!”: in the second row 104, the player has five matched numbers to make the bingo. The base game is then paused, as all called winning numbers are displayed on the display device. The fundamental elements of the wagered side bet are all the winning numbers drawn to date (2-6-8-10-16-22-25-30-37-40-41-51-55-56-73-74) as shown in the display device 106. It is noted that not all of the drawn numbers to date are represented on the bingo wagering card. The processor then determines the highest number X (74) from the said winning numbers, and the lowest number Y (2) from the winning numbers. X−Y determines the winning side bet number, and the side bet is then resolved against a predetermined paytable (not shown). The highest number from all drawn numbers is 74, and the lowest number from all drawn numbers is 2, (74−2) so the final value for the side bet is 72.

It should be noted that any determined winning side bet number may pertain to either all wagered bingo cards in play, or only the wagered bingo card that achieved the winning pattern.

### Lottery

In yet a further embodiment of the present invention, a player makes a wager to play a side bet on a lottery numbers game comprising a) a predetermined amount of numbers each randomly drawn from a same set of predetermined unique numbers; b) a predetermined amount of numbers randomly drawn from a predetermined set of unique numbers; or c) a predetermined amount of numbers randomly drawn from a first predetermined set of unique numbers plus at least one number randomly drawn from a second predetermined set of unique numbers. For example in a), the lottery game may be a number game that draws four numbers, with each number drawn from the set of numbers 0 through 9 inclusive; in b), the lottery game may be a number game that draws five numbers from the set of numbers 1 through 50 inclusive; and in c), the lottery game may be a number game that draws five numbers from the set of numbers 1 through 75 inclusive and separately draws one number from the set of numbers 40 through 75 inclusive. In each case (a, b and c), the drawn numbers are the fundamental elements of the side bet, and the fundamental elements are analyzed to determine the highest number X and the lowest number Y. The lowest number Y may in separate embodiments be either subtracted from, or added to, the highest number X to provide a final value. The final value is then resolved against a predetermined paytable. As specific examples and using (X−Y) as the determinant, in a), a draw of 6-6-0-4 would have a side bet final value of 6 (6−0); in b), a draw of 13-18-20-24-48 would have a side bet final value of 35 (48−13); and in c), a draw of 6-16-30-64-72 with a separate draw of 73 may have a side bet final value of 66 (72−6) if only the first five draw numbers are the fundamental elements, or a final value of 67 (73−6) if all of the six draw numbers are the fundamental elements. In c), if the separate draw number is either the highest or the lowest number of the fundamental elements, the prize as defined by a predetermined paytable may be increased.

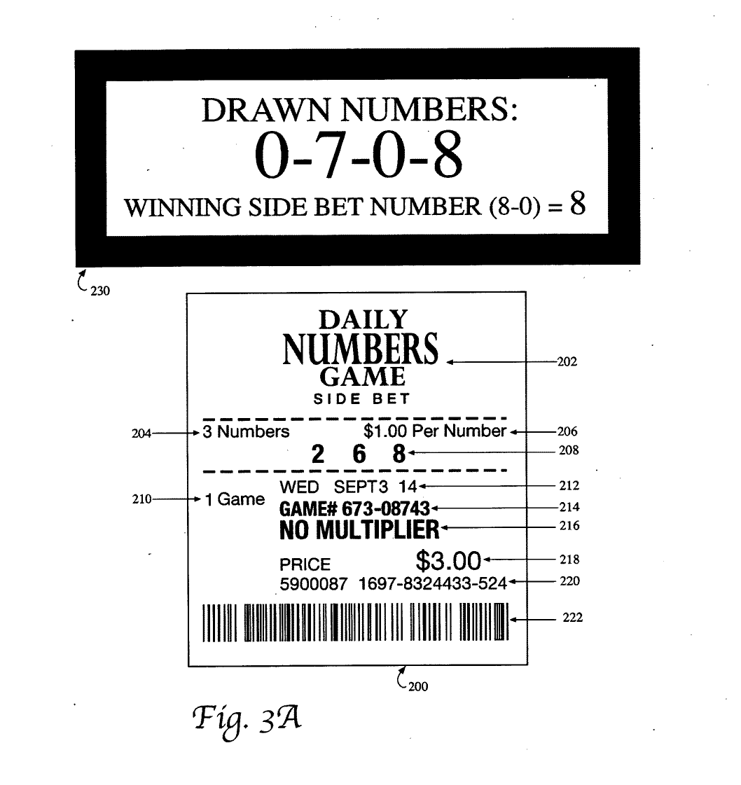

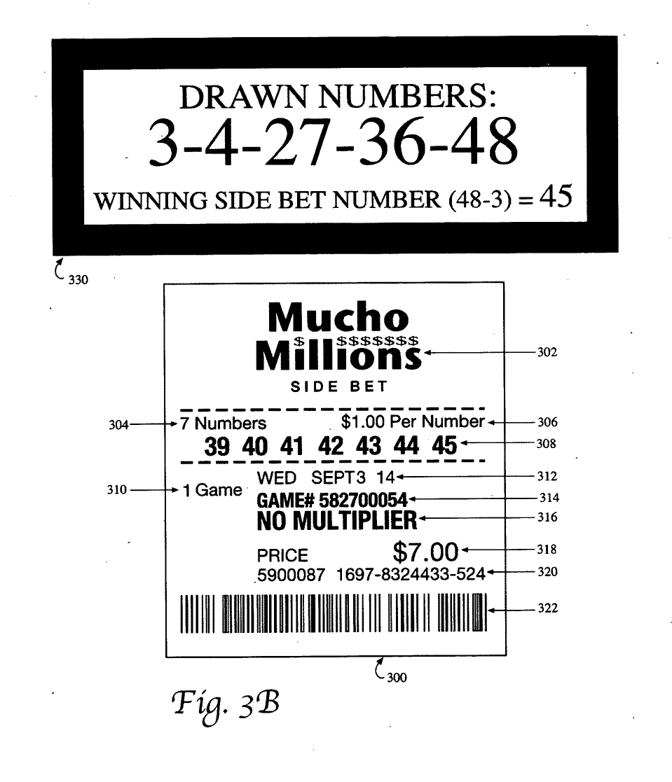

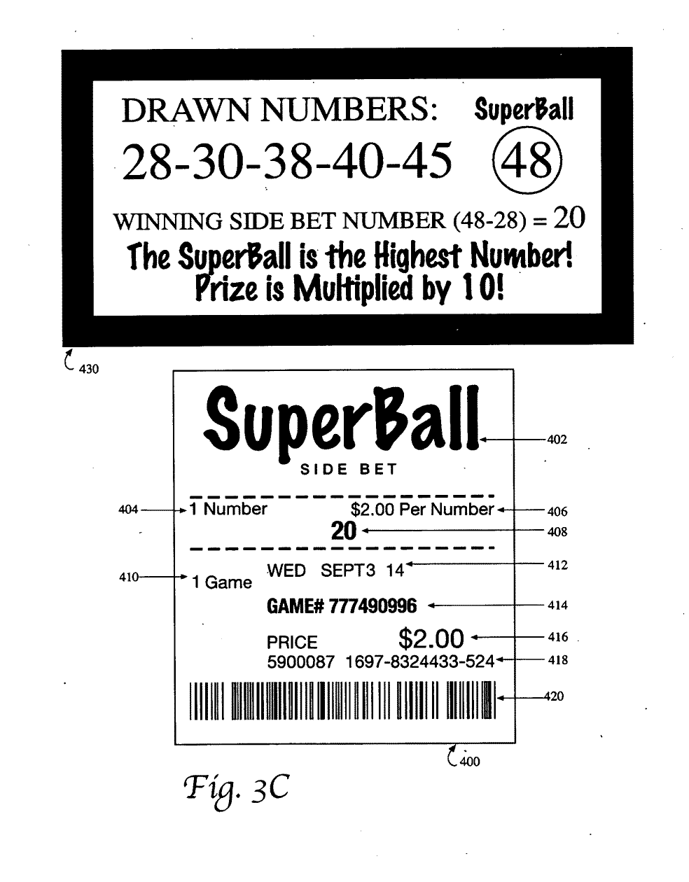

References to FIGS. 3A, 3B and 3C will assist in further understanding of the practice of the present invention. Various lottery numbers games are described in the Figures below.

FIG. 3A shows a Daily Numbers Game based on the descriptions a) in the above LOTTERY disclosure (in this example, with a final draw of four numbers) comprising a play ticket 200, printed or virtual. The play ticket displays an area 202 with the name of the lottery side bet, the total amount of side bet numbers per game selected by the player 204, the amount wagered per side bet number 206, and the side bet numbers selected by the player 208. The date of the game(s) played 212 is also shown. The amount of games played 210, the game number(s) referring to each specific game played 214, a determination as to whether or not the player has chosen to play a multiplier bonus 216, and the total price of the play ticket 218 are shown. A security identification number 220 for the play ticket is shown and a UPC code 222 is provided. A monitor screen display device 230 is also shown. Four numbers are each randomly selected from a same predetermined set of numbers from 0 to 9 inclusive. Each selected number is a winning number and is displayed on the display device 230. The fundamental elements of the side bet are the four winning numbers (0-7-0-8). The processor then determines the highest number X (8) from the four said winning numbers, and the lowest number Y (0) from the four said winning numbers. X−Y determines the winning side bet number, and the side bet is then resolved against a predetermined paytable (not shown). The winning number for the side bet is (8-0)=8 final value.

FIG. 3B shows a “Mucho Millions” Game based on the descriptions b) in the above LOTTERY disclosure (in this example, with a final draw of five numbers) comprising a play ticket 300, printed or virtual. The play ticket displays an area 302 with the name of the lottery side bet, the total amount of side bet numbers per game selected by the player 304, the amount wagered per side bet number 306, and the side bet numbers selected by the player 308. The date of the game(s) played 312 is also shown. The amount of games played 310, the game number(s) referring to each specific game played 314, a determination as to whether or not the player has chosen to play a multiplier bonus 316, and the total price of the play ticket 318 are shown. A security identification number 320 for the play ticket is shown and a UPC code 322 is provided. A monitor screen display device 330 is also shown. Five numbers are each randomly selected from a predetermined set of numbers from 1 through 50 inclusive. Each selected number is a winning number and is displayed on the display device 330. The fundamental elements of the side bet Ire the five winning numbers (3-4-27-36-48). The processor then determines the highest number X (48) from the five said winning numbers, and the lowest number Y (3) from the five said winning numbers. X−Y determines the winning side bet number, and the side bet is then resolved against a predetermined paytable (not shown). The winning number for the side bet is (48-3)=45 final value.

FIG. 3C shows a “SuperBall” Game based on the descriptions c) in the above LOTTERY disclosure (in this example, with a final draw of five numbers, plus one Superball draw) comprising a play ticket 400, printed or virtual. The play ticket displays an area 402 with the name of the lottery side bet, the total amount of side bet numbers per game selected by the player 404, the amount wagered per side bet number 406, and the side bet number selected by the player 408. The date of the game played 412 is also shown. The amount of games played 410, the game number(s) referring to each specific game played 414, and the total price of the play ticket 416 are shown. A security identification number 418 for the play ticket is shown and a UPC code 420 is provided. A monitor screen display device 430 is also shown. Five numbers are each randomly selected from a predetermined set of numbers from 1 through 75 inclusive. In addition, a special “Superball” number is randomly drawn from a predetermined set of numbers 40 through 75 inclusive. Each selected number is a winning number and is displayed on the display device 430. The fundamental elements of the side bet are the five winning numbers (28-30-38-40-45) and (48). The processor then determines the highest number X (48) from the six said winning numbers, and the lowest number Y (28) from the six said winning numbers. X−Y determines the winning side bet number, and the side bet is then resolved against a predetermined paytable (not shown). The winning number for the side bet is (48−28)=20 final value. Here the player has placed a side bet on the number 20 400, so the player wins his side bet according to the predetermined paytable; and due to the fact that the highest number 48 is the Superball number, the player wins an increased amount (10× the win, for example).

The above embodiments provide the basis of the gameplay for both a live numbers game and electronic versions of the present invention. The various components of the electronic version are controlled by a central processing unit (CPU), also referred to herein as a controller or processor (such as a microcontroller or microprocessor). To provide gaming functions, the controller executes one or more game programs stored in a computer readable storage medium, in the form of memory. The controller performs the random selection using a random number generator (RNG) of an outcome from the plurality of possible outcomes of the wagering game. Alternatively, the random event may be determined at a remote controller. The remote controller may either use an RNG or a pooling scheme for its central determination of a game outcome. It should be noted that The controller may include one or more microprocessors, including, but not limited to, a master processor, a slave processor, and a secondary or parallel processor.

The controller is also coupled to the system memory and a money/credit detector. The system memory may comprise a volatile memory (e.g., a random-access memory [RAM]) and a non-volatile memory (e.g., an EPROM). The system memory may include multiple RAM and multiple program memories. The money/credit detector signals the processor that money and/or credits were input via the value input device. Preferably, these components are located within the housing of the gaming machine. However, as explained above, these components may be located outboard of the housing and connected to the remainder of the components of the gaming machine via a variety of different wired or wireless connection methods.

The controller is also connected to, and controls, the primary display, the player input device, and a payoff mechanism. The payoff mechanism is operable, in response to instructions from the controller, and awards a payoff to the player in response to certain winning outcomes that might occur in the basic game or the side bet(s). The payoff may be provided in the form of points, bills, tickets, coupons, cards, etc. For example, the payoff mechanism may include both a ticket printer and a coin outlet. However, any of a variety of payoff mechanisms well known in the art may be implemented, including cards, coins, tickets, smartcards, cash, etc. One or more pay tables stored in the system memory determine the payoff amounts distributed by the payoff mechanism.

Communications between the controller and both the peripheral components of the gaming machine and external systems occur through input/output (I/O) circuits. More specifically, the controller directs and receives inputs from the peripheral components of the gaming machine through the input/output circuits. Further, the controller communicates with the external systems via the I/O circuits and a communication path (e.g., serial, parallel, IR, RC, 10bT, etc.). The external systems may include a gaming network, other gaming machines, a gaming server, communications hardware, or a variety of other interfaced systems or components. Even though the I/O circuits may be shown as a single block, it should be noted that each of the I/O circuits may include different types of I/O circuits.

Controller, as used herein, comprises any combination of hardware, software, and/or firmware that may be disposed or reside inside and/or outside the gaming machine that may communicate with and/or control the transfer of data between the gaming machine and a bus, another computer, processor, or device and/or a service and/or a network. The controller may comprise one or more controllers or processors. The controller may, alternatively, comprise a CPU in combination with other components, such as the I/O circuits and the system memory.

Although specific examples and specific rules have been provided in this discussion, these specifics are intended to be only support for the generic concepts of the invention and are not intended to be absolute limits in the scope of the technology discussed.

What is claimed:

1. A method of providing a side bet associated with a base wagering numbers game for at least one player on a gaming system comprises: at least one processor; a gaming apparatus having at least one input device and at least one display device; and at least one memory device which stores a plurality of instructions which, when executed by the at least one processor, cause the at least one processor to operate with the at least one display device and the at least one input device to provide the steps to:
a) enable a player to place at least one wager on at least one side bet associated with a base wagering numbers game;
b) establish at least one predetermined initial set of unique numbers to be used in the play of the base wagering numbers game;
c) provide a predetermined set of unique numbers as wagerable numbers for the side bet;
d) provide at least one predetermined amount of randomly selected numbers from the at least one predetermined initial set of numbers;
e) identify at least some of the predetermined amount of randomly selected numbers as fundamental elements of the at least one side bet;
f) determine a highest number X from the fundamental elements and a lowest number Y from the fundamental elements;
g) determine a final value according to a mathematical formula based on the highest number X and the lowest number Y;
h) establish a predetermined paytable for the wagerable numbers of the side bet associated with the at least one side bet wherein payouts are based on at least the odds of occurrence of the final value; and
i) resolve the at least one side bet according to the predetermined paytable.

2. The method of claim 1 wherein the base wagering numbers game is Keno.

3. The method of claim 2 wherein all of the predetermined amount of randomly selected numbers are fundamental elements of the at least one side bet.

4. The method of claim 2 wherein the mathematical formula based on X and Y is the difference of X and Y (X−Y).

5. The method of claim 2 wherein the mathematical formula based on X and Y is the sum of X and Y (X+Y).

6. The method of claim 1 wherein the base wagering numbers game is a lottery numbers game.

7. The method of claim 6 wherein the mathematical formula based on X and Y is the difference of X and Y (X−Y).

8. The method of claim 6 wherein the mathematical formula based on X and Y is the sum of X and Y (X+Y).

9. The method of claim 6 wherein the lottery numbers game comprises a predetermined amount of numbers each randomly selected from a same initial predetermined set of unique numbers.

10. The method of claim 9 wherein all of the randomly selected numbers are the fundamental elements of the at least one side bet.

11. The method of claim 6 wherein the lottery numbers game comprises a predetermined amount of numbers randomly selected from an initial predetermined set of unique numbers.

12. The method of claim 11 wherein all of the randomly selected numbers are the fundamental elements of the at least one side bet.

13. The method of claim 6 wherein the lottery numbers game comprises a predetermined amount of numbers randomly selected from a first initial predetermined set of unique numbers plus at least one number randomly selected from a second initial predetermined set of unique numbers.

14. The method of claim 13 wherein only the randomly selected numbers from the first initial predetermined set of unique numbers are the fundamental elements of the at least one side bet.

15. The method of claim 13 wherein all of the predetermined amount of randomly selected numbers are fundamental elements of the at least one side bet.

16. The method of claim 1 wherein the base wagering numbers game is Bingo.

17. The method of claim 16 wherein each randomly selected number from the predetermined amount of randomly selected numbers is provided one at a time, and the least one side bet is resolved before all of the amount of randomly selected numbers is provided.

18. The method of claim 16 wherein the mathematical formula based on X and Y is the difference of X and Y (X−Y).

19. The method of claim 16 wherein the mathematical formula based on X and Y is the sum of X and Y (X+Y).

20. The method of claim 1 wherein a base numbers game wager is mandatory when placing the at least one side bet wager.

21. The method of claim 1 wherein a base numbers game wager is not mandatory when placing the at least one side bet wager.
